(19) United States
(12) Patent Application Publication
(10) Pub. No.: US 2026/0111144 A1
(43) Pub. Date: Apr. 23, 2026

(54) DATA PROCESSING SYSTEM AND METHOD, AND MEDIUM

(71) Applicant: Suzhou MetaBrain Intelligent Technology Co., Ltd., Suzhou, Jiangsu (CN)

(72) Inventors: Qianqian ZHAO, Suzhou, Jiangsu (CN); Yanwei WANG, Suzhou, Jiangsu (CN); Rui HAO, Suzhou, Jiangsu (CN); Linge XIAO, Suzhou, Jiangsu (CN)

(21) Appl. No.: 19/469,080

(22) PCT Filed: Sep. 30, 2024
(86) PCT No.: PCT/CN2024/122669

§ 371 Date: Sep. 25, 2025

(30) Foreign Application Priority Data
Feb. 28, 2024 (CN) 202410220698.1

(51) Int. Cl. G06F 3/06; G06N 20/00

(52) U.S. Cl. CPC G06F 3/0655; G06F 3/0604; G06F 3/0679; G06N 20/00

(57) ABSTRACT

The present application discloses a data processing system and method, and a medium in the technical field of model training. According to the present application, a model training task is executed using acceleration devices in a host; and train data, intermediate results and weight data are stored using a memory board in the host, whereby the host does not need to execute the task or store the data.

### CROSS-REFERENCE TO RELATED APPLICATION

This application claims priority to Chinese Patent Application No. 202410220698.1, filed on Feb. 28, 2024 in China National Intellectual Property Administration and entitled “Data Processing System and Method, and Medium”, which is hereby incorporated by reference in its entirety.

### FIELD

The present application relates to the technical field of model training, in particular to a data processing system and method, and a medium.

### BACKGROUND

At present, when a model training task is executed using a host, a large amount of data needs to be stored in host memory; and intermediate results, weights and other data of model training also need to be stored in the host memory. This will increase a load on the host, with slow training efficiency. When a training program goes wrong, it takes a lot of memory access time to save a complete model weight, and the model weight is at risk of power failure and loss.

### SUMMARY

In view of this, an object of the present application is to provide a data processing system and method, and a medium. A solution is as follows:

According to a first aspect, the present application provides a data processing system including a plurality of hosts, where any host includes: a plurality of acceleration devices and at least one memory board;
the plurality of hosts include a control host that divides a same model training task into a plurality of subtasks and distributes the plurality of subtasks to the plurality of hosts;
the plurality of hosts execute the received subtasks using the plurality of acceleration devices in the plurality of hosts in parallel, and store train data, intermediate results, and weight data corresponding to the respective subtasks using the memory boards in the plurality of hosts; and
the control host collects and processes the weight data stored by the memory boards in the plurality of hosts using the memory board in the control host, and writes the latest weight data obtained by processing back to the memory boards in the plurality of hosts.

In another aspect, any memory board includes: a non-volatile storage module, where the non-volatile storage module includes a storage controller and a non-volatile storage area;
the storage controller is configured to perform a memory allocation operation, a memory release operation, a data storage operation, an address mapping operation and/or memory request scheduling on the non-volatile storage area; and
the non-volatile storage area is configured to respond to the memory allocation operation, the memory release operation, the data storage operation, the address mapping operation, and/or the memory request scheduling performed by the storage controller.

In another aspect, the non-volatile storage area is divided into a train data area, a full model weight data area, a subtask weight data area, and other areas.

In another aspect, any memory board further includes: a board scheduler, where the board scheduler is configured to implement data consistency between memory of a host to which a current memory board belongs and the non-volatile storage area in the current memory board by a compute express link (CXL) protocol.

In another aspect, any memory board further includes: a priority arbiter, where the priority arbiter determines a priority according to a memory access address in a received memory access request, and processes the memory access request according to the determined priority.

In another aspect, the memory access request is at least one of a request for a host to which a current memory board belongs to access the non-volatile storage area in the current memory board, a request for the acceleration devices in a host to which a current memory board belongs to access the non-volatile storage area in the current memory board, a request for a current memory board to access the non-volatile storage area in the current memory board, and a request for a current memory board to access a memory board in another host.

In another aspect, the priority arbiter determines that the priority is the highest in response to determining that the memory access request is a request for the acceleration devices in a host to which a current memory board belongs to access the non-volatile storage area in the current memory board.

In another aspect, the priority arbiter determines the priority according to a preset strategy in response to determining that the memory access request is not a request for the acceleration devices in a host to which a current memory board belongs to access the non-volatile storage area in the current memory board.

In another aspect, any memory board further includes: a board computing unit, where the board computing unit is configured to collect and compute the weight data.

In another aspect, any memory board further includes: a network module, where the network module is configured to communicate with a memory board in another host through a target protocol.

In another aspect, the network module is configured to:
synchronize the weight data stored by a memory board to which the network module belongs to a memory board in another host through a remote direct memory access (RDMA) protocol; and
receive the weight data sent by the memory board in the another host through the RDMA protocol.

In another aspect, the control host initializes the memory boards in the plurality of hosts, configures an interaction mode, a memory size and a start offset address of each memory board, uniformly addresses each memory board to obtain an addressing table, and enables access rights between the memory boards.

In another aspect, any host or any memory board or any acceleration device accesses a target memory address through a base address and an offset address corresponding to the target memory address, where the target memory address is an address of a non-volatile storage area in a non-current memory board.

In another aspect, any host maps an address of the non-volatile storage area in the memory board of the host to host memory space through a CXL protocol, and implements conversion between a host memory address and a board memory address according to an address mapping relationship obtained by mapping.

In another aspect, any host divides the received subtask into a plurality of task blocks according to the number of the acceleration devices in the host, distributes the plurality of task blocks to the acceleration devices in the host, and controls the acceleration devices in the host to run the plurality of task blocks in parallel.

In another aspect, the control host computes an average value of the weight data stored by the memory boards in the plurality of hosts, and takes the average value as the latest weight data.

In another aspect, any acceleration device includes a device scheduler, where the device scheduler is configured to implement data consistency between memory of a current acceleration device and memory of a host to which the current acceleration device belongs through the CXL protocol.

In another aspect, any acceleration device includes a plurality of device computing units, where the plurality of device computing units are configured to execute the received task block; and the task block is obtained by dividing the subtask received by the current acceleration device according to the number of the acceleration devices in the host to which the current acceleration device belongs.

In another aspect, any host or any memory board or any acceleration device determines that the target memory address is local according to the addressing table, and accesses the target memory address through a peripheral component interconnect express (PCIE) protocol; and/or any host or any memory board or any acceleration device determines that the target memory address is not local according to the addressing table, and accesses the target memory address through the RDMA protocol.

In another aspect, any acceleration device stores intermediate weights in a training process obtained by executing the subtask into the subtask weight data area of the memory board of a same host; and sets a flag corresponding to the subtask weight data area from 0 to 1 in response to determining that the subtask weight data area is full.

In another aspect, the board computing unit in any memory board is configured to:
read the intermediate weights in a local or remote subtask weight data area according to the addressing table, and set a flag corresponding to the respective subtask weight data area from 1 to 0; and
compute an average value of the read data, and write the average value to a local or remote full model weight data area according to the addressing table.

According to a second aspect, the present application provides a data processing method, which is applied to a distributed system, where the distributed system includes a plurality of hosts, and any host includes: a plurality of acceleration devices and at least one memory board;
the plurality of hosts include a control host that divides a same model training task into a plurality of subtasks and distributes the plurality of subtasks to the plurality of hosts;
the plurality of hosts execute the received subtasks using the plurality of acceleration devices in the plurality of hosts in parallel, and store train data, intermediate results, and weight data corresponding to the respective subtasks using the memory boards in the plurality of hosts; and
the control host collects and processes the weight data stored by the memory boards in the plurality of hosts using the memory board in the control host, and writes the latest weight data obtained by processing back to the memory boards in the plurality of hosts.

In another aspect, a network module in any memory board synchronizes the weight data stored by a current memory board to a memory board in another host through a remote direct memory access (RDMA) protocol; and receives the weight data sent by the memory board in the another host through the RDMA protocol.

In another aspect, the control host initializes the memory boards in the plurality of hosts, configures an interaction mode, a memory size and a start offset address of each memory board, uniformly addresses each memory board to obtain an addressing table, and enables access rights between the memory boards.

According to a third aspect, the present application provides a non-transitory computer-readable storage medium, where the non-transitory computer-readable storage medium stores computer-readable instructions that, when executed by one or more processors, implement the data processing method disclosed above.

According to the above solution, the present application provides a data processing system which includes a plurality of hosts, where any host includes: a plurality of acceleration devices and at least one memory board; the plurality of hosts include a control host that divides a same model training task into a plurality of subtasks and distributes the plurality of subtasks to the plurality of hosts; the plurality of hosts execute the received subtasks using the plurality of acceleration devices in the plurality of hosts in parallel, and store train data, intermediate results, and weight data corresponding to the respective subtasks using the memory boards in the plurality of hosts; and the control host collects and processes the weight data stored by the memory boards in the plurality of hosts using the memory board in the control host, and writes the latest weight data obtained by processing back to the memory boards in the plurality of hosts.

### BRIEF DESCRIPTION OF THE DRAWINGS

In order to more clearly explain the technical solutions in embodiments of the present application or related technologies, drawings that need to be used in the description of the embodiments or related technologies will be briefly introduced below, and it is obvious that drawings in the following description are only embodiments of the present application, and for those of ordinary skill in the art, other drawings may be obtained according to the provided drawings without making creative labor.

FIG. 1 is a schematic diagram of a data processing system disclosed by the present application;

FIG. 2 is a schematic diagram of a distributed cluster disclosed by the present application;

FIG. 3 is a schematic diagram of a memory board disclosed by the present application;

FIG. 4 is a schematic diagram of an acceleration device disclosed by the present application;

FIG. 5 is a flowchart of a data processing method disclosed by the present application;

FIG. 6 is a structural diagram of a server provided by the present application;

FIG. 7 is a structural diagram of a terminal provided by the present application; and

FIG. 8 is a structural diagram of a non-transitory computer storage medium provided by the present application.

### DETAILED DESCRIPTION

Hereinafter, technical solutions in embodiments of the present application will be clearly and completely described with reference to accompanying drawings in the embodiments of the present application, and it is obvious that the described embodiments are only a part of the embodiments of the present application, but not all the embodiments. Based on the embodiments in the present application, all other examples obtained by those of ordinary skill in the art without making creative efforts fall within the scope of protection of the present application.

Large model training refers to a process of using large-scale data sets and computing resources to train deep learning models. Large models usually have more parameters and deeper network structures, and may learn more complex and abstract feature representations. This allows the large models to have a stronger expression capability when dealing with complex tasks and large-scale data, and may better capture potential patterns and relationships in the data. By increasing the parameters and number of layers, the performance and effect of the model may be improved. For example, in the field of natural language processing, the large models may better understand and generate natural languages, showing higher semantic accuracy and language fluency. In a field of computer vision, the large models may more accurately perform tasks such as object recognition and image generation. At the same time, the large models have stronger generalization capabilities, that is, the large models perform well on never saw data. By increasing the capacity and complexity of the models, the large models may better adapt to different data distributions and task requirements, thereby improving the generalization capabilities of the models on new data. By training on large-scale data, more general feature representations may be learned. This allows the large models to perform better in transfer learning tasks and may transfer learned knowledge to new tasks and fields.

At the same time, large model training faces some difficulties and challenges. The most obvious challenge is that the large models have extremely high demand for training equipment, which mainly includes the following aspects: processor performance: large model training requires high-performance processors to perform computation. Graphics processors or dedicated AI (Artificial Intelligence) accelerators are usually configured to accelerate model training. These processors have parallel computing power and high-speed floating-point computing power, which may significantly speed up training. Memory capacity: model parameters in large model training are usually very large and require a large amount of memory to store and update parameters. For a single computing node, a memory capacity needs to be able to meet the storage requirements of model parameters. If the memory capacity is insufficient, model parallelization or distributed training techniques may be needed to solve a memory limitation problem. Storage system: the size of data generated by large model training is large, and a fast storage system is required to store and read the data. High-speed solid-state drives or network storage (such as distributed file systems) may provide enough storage bandwidths and capacities to meet the needs of large-scale training. Network connection: large model training usually requires communication and synchronization between a plurality of computing nodes. Therefore, high-speed network connections are needed to ensure the efficiency and stability of data transmission between the nodes. High-performance networks such as high-speed Ethernet may meet the demand for large-scale training. Distributed computing architecture: for large-scale model training, it may be necessary to use a distributed computing architecture to assign computation tasks to the plurality of computing nodes for parallel computation. This may improve the training speed and efficiency. The distributed computing architecture needs to have functions such as task scheduling, node management and communication coordination.

At present, when a model training task is executed using a host, a large amount of data needs to be stored in host memory; and intermediate results, weights and other data of model training also need to be stored in the host memory. This will increase a load on the host, with slow training efficiency. When a training program goes wrong, it takes a lot of memory access time to save a complete model weight, and the model weight is at risk of power failure and loss. Therefore, the present application provides a data processing solution, which may reduce a host load and improve the efficiency of model training.

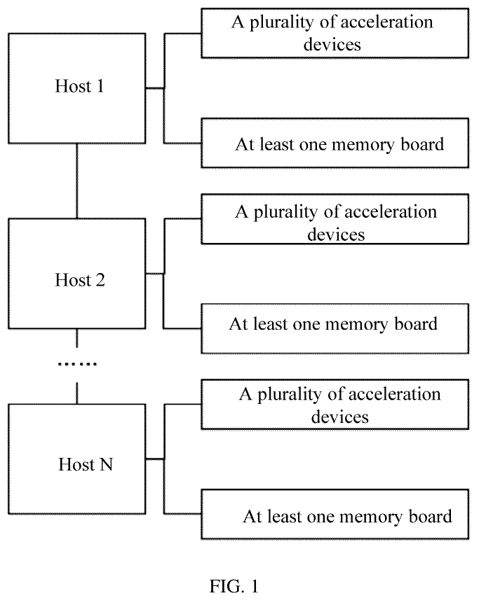

Referring to FIG. 1, some embodiments of the present application discloses a data processing system, which includes a plurality of hosts, where any host includes: a plurality of acceleration devices and at least one memory board. Acceleration devices include field-programmable gate array (FPGA) accelerator cards, graphics processing unit (GPU) accelerator cards, etc.

In some embodiments, the plurality of hosts include a control host. The control host divides a same model training task into a plurality of subtasks and distributes the plurality of subtasks to the plurality of hosts. The plurality of hosts execute the received subtasks using the plurality of acceleration devices in the plurality of hosts in parallel, and store train data, intermediate results, and weight data corresponding to the respective subtasks using the memory boards in the plurality of hosts. the control host collects and processes the weight data stored by the memory boards in the plurality of hosts using the memory board in the control host, and writes the latest weight data obtained by processing back to the memory boards in the plurality of hosts. The memory board may be a memory expansion card implemented based on FPGA.

In the embodiments, the model training task is configured to implement training of various intelligent models. The intelligent models may have any structure, and may be configured to implement a data encryption task, a data decryption task, an image recognition task, an image classification task, and the like. The host is a server. The data processing system configured by the plurality of hosts may be a distributed system. Each host in the distributed system may implement resource sharing, thereby accelerating a computation speed. In these embodiments, the model training task is divided into several subtasks running in parallel. These subtasks are distributed to different host nodes, whereby the subtasks may run on these host nodes at the same time. In this way, the computation speed is accelerated. In addition, the distributed system has a computing migration function. In response to determining that a load on a certain host node is too heavy, part of jobs may be moved to other host nodes for execution, thereby reducing the load of the previous host node. This job migration is called load balancing. In addition, the distributed system has high reliability. In response to determining that one node has failed, the remaining nodes may continue to operate, and the system will not collapse due to the failure of one or a few nodes. Therefore, the distributed system has good fault tolerance performance. The system may also detect the failure of the node and take appropriate measures to make the node restore from the failure. After the system determines the node where the fault is located, the system no longer uses the node to provide services until the node restores normal operation. Functions of the failed node may be completed by other nodes. In response to determining that the failed node is restored or repaired, the system may smoothly integrate the node into the system.

In a single host, at least one switch device supporting a technical specification compute express link (CXL) protocol may be included. An upstream port of the switch device is configured to connect to the host, and a downstream port is configured to connect to other switch devices, multiple acceleration devices, and at least one memory board. In some embodiments, after the downstream port of the switch device completes configuration of configuration space and allocation of a base address register (BAR) bus base address, each downstream device may periodically broadcast own free memory information to each other through a peripheral component interconnect express (PCIE, a high-speed serial computer extension bus standard) interface, thereby implementing direct PCIE communication between the downstream devices. The switch device may well implement communication and interconnection between the host and the downstream devices of the host. The PCIE is high-speed serial point-to-point dual-channel high-bandwidth transmission, and the connected devices are allocated with exclusive channel bandwidths. PCI Express also has various specifications, from PCI Express x1 to PCI Express x32. The specifications may meet needs of low-speed devices and high-speed devices that will appear in a certain period of time in the future. The interface of PCI-Express is a PCIE 3.0 interface, with a bit rate of 8 Gbps, which is about twice the bandwidth of a product of the previous generation, and includes a series of important functions such as transmitter and receiver equalization and clock data restoration to improve data transmission and data protection performance. A PCI Express bus link supports full duplex communication between any two endpoints. The channel consists of two differential signal pairs (one for receiving data, the other for transmitting data), and a pair of differential reference clocks. Therefore, each channel consists of four data lines. Conceptually, each channel serves as a full-duplex byte stream, transmitting data packets in an 8-bit byte format simultaneously in both directions between link endpoints. A physical PCI Express link may contain 1 to 32 channels.

The CXL protocol is compatible with the PCIE standard. The protocol may solve a consistency problem of cache and memory access of heterogeneous devices, whereby the memory of acceleration devices, the memory of host and central processing unit (CPU) cache may be quickly accessed globally by devices supporting the CXL protocol. The CXL technology maintains memory consistency between CPU memory space and memory on connected devices, and may support resource sharing (or a memory pool) for higher performance, reduce complexity of a software stack, and reduce overall system costs. Therefore, through a CXL interface, a CPU may communicate with GPU acceleration devices, FPGA acceleration devices, etc., thereby bringing higher data access efficiency and lower local data access delay. The CXL consists of three dynamically multiplexed sub-protocols on a single link, including a PCIE-like (input/output) IO protocol (i.e. CXL.io), a cache protocol (i.e. CXL.each), and a memory access protocol (i.e. CXL.memory). All the sub-protocols or only one sub-protocol may be enabled according to a certain acceleration device usage pattern. For operations such as discovery and enumeration, error reporting, and host physical address lookup, the CXL.io protocol needs to be enabled. A major advantage of the CXL is providing a low-latency, high-bandwidth path for the accelerate devices to access the system. Memory cache consistency of the CXL allows memory resources to be shared between a host CPU and the acceleration devices.

In some examples, the downstream acceleration devices of the switch device in the host may communicate directly with each other in a direct memory access (DMA) method without using the host. Other acceleration devices in the current host for data processing are determined according to a memory free capacity and an accelerator card function in response to that any acceleration device needs to transmit data; and memory free information of the other acceleration devices in the current host is queried. Then, the memory in the current host is configured to directly access a controller and the memory free information, and the current need for data transmission is written into the memory of other acceleration devices in a mode of memory direct access. The switch device is a multi-port device. A main function is to forward data between different ports. A data interface may be reserved for docking with other devices.

In some implementations, any memory board includes: a non-volatile storage module, where the non-volatile storage module includes a storage controller and a non-volatile storage area. The storage controller is configured to perform a memory allocation operation, a memory release operation, a data storage operation, an address mapping operation and/or memory request scheduling on the non-volatile storage area. The non-volatile storage area is configured to respond to the memory allocation operation, the memory release operation, the data storage operation, the address mapping operation, and/or the memory request scheduling performed by the storage controller. In some embodiments, the non-volatile storage area is divided into a train data area, a full model weight data area, a subtask weight (weight of a layer in a model) data area, and other areas.

In some implementations, any memory board further includes: a board scheduler. In some embodiments, the board scheduler may be implemented using an FPGA or an application specific integrated circuit (ASIC) that solidifies related functions. The board scheduler is configured to implement data consistency between memory of the host to which the current memory board belongs and the non-volatile storage area in the current memory board by a compute express link (CXL) protocol. In some embodiments, the board scheduler implements a correlation engine by virtue of a data consistency standard provided by the CXL protocol, thereby utilizing this engine to instantly synchronize data in the host memory and the non-volatile storage area in the memory board.

In some implementations, any memory board further includes: a priority arbiter. The priority arbiter consists of a priority list, a priority queue and an arbitration module. The priority list is configured to store priority levels and corresponding priority events. The priority queue consists of multiple queues. Each priority has one queue which is configured for storage access events of each priority, and adopts a first-in, first-out method. The arbitration module is configured to solve an access order when an access conflict occurs, and stores low-priority access events to a corresponding access queue. The priority arbiter may be implemented using FPGA hardware or software.

The priority arbiter determines a priority according to a memory access address in a received memory access request, and processes the memory access request according to the determined priority. In some embodiments, the memory access request is a request for a host to which a current memory board belongs to access the non-volatile storage area in the current memory board, a request for the acceleration devices in a host to which a current memory board belongs to access the non-volatile storage area in the current memory board, a request for a current memory board to access the non-volatile storage area in the current memory board, and/or a request for a current memory board to access a memory board in another host. It is thus clear that the system supports the host to which the current memory board belongs to access the non-volatile storage area in the current memory board, the acceleration devices in the host to which the current memory board belongs to access the non-volatile storage area in the current memory board, the current memory board to access the non-volatile storage area in the current memory board and/or mutual access of the memory boards of different hosts. In some embodiments, the priority arbiter determines that the memory access request is a request for the acceleration devices in the host to which the current memory board belongs to access the non-volatile storage area in the current memory board, and thus determines that the priority is the highest. In some embodiments, the priority arbiter determines the priority according to a preset strategy in response to determining that the memory access request is not a request for the acceleration devices in the host to which the current memory board belongs to access the non-volatile storage area in the current memory board. In some embodiments, in the preset strategy, the priorities of the different requests may be set, for example: the priority of the request for the acceleration devices in the host to which the current memory board belongs to access the non-volatile storage area in the current memory board is the highest, the priority of the request for the current memory board to access the non-volatile storage area in the current memory board is the second, the priority of the mutual access of the memory boards of different hosts is the third, and the priority of the request for the host to which the current memory board belongs to access the non-volatile storage area in the current memory board is the lowest.

A board computing unit may be a multi-core parallel ASIC, or an ASIC or a FPGA supporting deep learning algorithms. The board computing unit is configured to collect and compute the weight data, and may acquire and compute the weight data output by the acceleration devices in the host where the current board is located and/or the acceleration devices in other hosts.

A network module is configured to communicate with a memory board in another host through a target protocol. In some embodiments, the network module may be an FPGA supporting protocols such as transmission control protocol (TCP)/remote direct memory access (RDMA) or an ASIC module integrating network protocols. The network module synchronizes the weight data stored by the memory board to which the network module belongs to the memory boards in the other hosts through a RDMA protocol or a transmission control protocol (TCP), and receives the weight data sent by the memory boards in the other hosts through the RDMA protocol. The RDMA may reduce network delay, directly transfer data to the non-volatile storage areas of different memory boards, and thus quickly transmit data on the different memory boards without any impact on a host operating system. In this way, a processing function of the host is not needed, thereby liberating the host memory and bandwidth and improving performance of the host system.

In some implementations, the control host initializes the memory boards in the plurality of hosts, configures an interaction mode, a memory size and a start offset address of each memory board, uniformly addresses each memory board to obtain an addressing table, and enables access rights between the memory boards. In some embodiments, any host or any memory board or any acceleration device accesses a target memory address through a base address and an offset address corresponding to the target memory address, where the target memory address is an address of a non-volatile storage area in a non-current memory board.

In some implementations, any host maps an address of the non-volatile storage area in the memory board of the host to host memory space through a CXL, and implements conversion between a host memory address and a board memory address according to an address mapping relationship obtained by mapping.

In some implementations, any host divides the received subtask into a plurality of task blocks according to the number of the acceleration devices in the host, distributes the plurality of task blocks to the acceleration devices in the host, and controls the acceleration devices in the host to run the plurality of task blocks in parallel. It is thus clear that the different acceleration devices in the same host run the subtask received by the host in parallel, thereby accelerating a task processing rate.

In some implementations, the control host computes an average value of the weight data stored by the memory boards in the plurality of hosts, and takes the average value as the latest weight data.

In some implementations, any acceleration device includes a device scheduler. The device scheduler may be implemented using an FPGA or an ASIC that solidifies related functions. The device scheduler is configured to implement data consistency between memory of a current acceleration device and memory of a host to which the current acceleration device belongs through the CXL protocol.

In some implementations, any acceleration device includes a plurality of device computing units. The device computing unit may be a multi-core parallel ASIC, or an ASIC or FPGA supporting deep learning algorithms. The plurality of device computing units are configured to execute the received task block; and the task block is obtained by dividing the subtask received by the current acceleration device according to the number of the acceleration devices in the host to which the current acceleration device belongs.

In some examples, the control host further includes a data transmission apparatus. The data transmission apparatus is configured to apply for direct connection to a memory address section of a corresponding remote device according to memory of at least one remote device, whereby the host may directly access the model training task stored in the remote device and the related data thereof through the data transmission apparatus. In some embodiments, the data transmission apparatus includes: an address resolution module and a plurality of memory access modules, where each memory access module is configured to apply for direct connection to a memory address section of a corresponding remote device according to memory of at least one remote device, and supports time-sharing multiplexing of different remote devices connected thereto. Each remote device directly accessed by each memory access module shares a processor and acceleration devices of a control host. The memory access module includes an RDMA unit.

In some implementations, the processor of the control host is further configured to: query the free memory access module in the data transmission apparatus according to the memory application request sent by any remote device; in response to querying the free memory access module, generate an address configuration operation for the free memory access module, and send the address configuration operation to the free memory access module. Accordingly, the free memory access module is configured to: configure a memory address range corresponding to any remote device carried by the address configuration operation in the module according to the address configuration operation, and establish a remote memory access connection with the current remote device. Accordingly, the address resolution module is configured to: record a mapping relationship between the memory address range, the current remote device, and the memory access module configured with the memory address range. The processor is further configured to: generate the address configuration operation for the free memory access module in the data transmission apparatus according to the memory application request sent by any remote device, and send the address configuration operation to the data transmission apparatus. Accordingly, the data transmission apparatus is configured to: cause the free memory access module to configure a memory address range corresponding to any remote device carried by the address configuration operation in the module according to the address configuration operation, and establish a remote memory access connection with the current remote device.

In some implementations, the processor of the control host is further configured to: return an application failure message to the corresponding remote device in response to no free memory access module being queried. In some implementations, the processor of the control host is further configured to: detect a memory space size of the memory address range according to the memory application request sent by any remote device; determine a memory mode that matches the memory space size; and manage the corresponding memory space according to the memory mode. In some implementations, the processor of the control host is further configured to: set a configurable address range size for each memory access module in the data transmission apparatus.

In another aspect, any host or any memory board or any acceleration device determines that the target memory address is local according to the addressing table, and accesses the target memory address through a peripheral component interconnect express (PCIE) protocol; and/or any host or any memory board or any acceleration device determines that the target memory address is not local according to the addressing table, and accesses the target memory address through the RDMA protocol. Any acceleration device stores intermediate weights in a training process obtained by executing the subtask into the subtask weight data area of the memory board of a same host, and sets a flag corresponding to the subtask weight data area from 0 to 1 in response to that the subtask weight data area is full. Accordingly, the board computing unit in any memory board reads the intermediate weights in a local or remote subtask weight data area according to the addressing table, and sets a flag corresponding to the respective subtask weight data area from 1 to 0; and computes an average value of the read data, and writes the average value to a local or remote full model weight data area according to the addressing table.

According to the embodiments, a model training task is executed using acceleration devices in a host; and train data, intermediate results and weight data are stored using a memory board in the host, whereby the host does not need to execute the task or store the data. In this way, a load of the host is reduced. The acceleration devices execute the model training task, whereby the model training efficiency may be improved. In a training process, the host needs to allocate tasks. A lot of computing and memory access work is offloaded to the acceleration devices and the memory board, whereby down risks in the training process and the difficulty to restore the model weight data may be reduced.

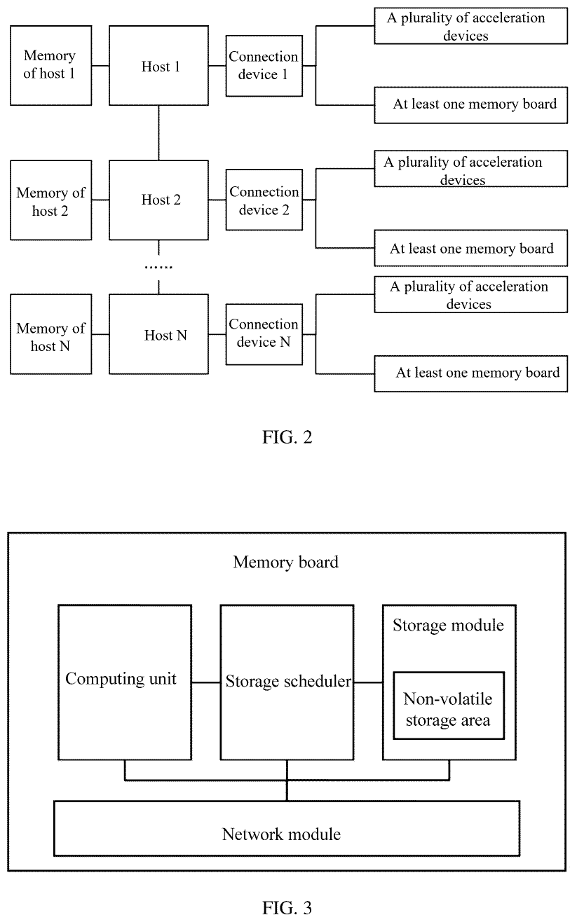

Referring to FIG. 2, these embodiments provides a distributed cluster which consists of several host nodes with cxl-pmem (i.e. memory board) and cxl-gpu (i.e. acceleration device). Each host node contains a CXL switch (connection device), a GPU acceleration device with several CXL interfaces, and one or more memory expansion CXL devices (i.e. memory boards) integrated with FPGAs.

Each host may connect multiple cascaded cxl switches, supporting up to 4096 memory boards. The acceleration devices and memory board devices are designed as cxl type 2 (including IO and cache) and connect to the host via the cxl switch. Because of device types thereof, the internal memory of the memory board may be exposed to the acceleration device and the corresponding host. The host memory may not be seen from the memory board. The acceleration device may access the host memory, and the memory board and the acceleration device access each other. The host may access the memory board, and vice versa, the memory board may also access the host.

Referring to FIG. 3, the memory board is a memory expansion card implemented by the FPGA, which includes following four modules: a computing unit, a storage scheduler (i.e. board scheduler), a persistent memory (PMEM) storage module (i.e. non-volatile storage module) and a network module.

The storage scheduler implements a device coherency engine (dcoh) through the CXL, which is configured to maintain memory consistency with the host, including a memory access queue and a priority arbiter. The memory access queue and priority arbiter are designed in the memory board. Memory access of this device is mainly composed of following types: the host reads and writes the PMEM storage module of the memory board; the acceleration device reads and writes the PMEM storage module of the memory board; the memory board reads and writes the PMEM storage module of the memory board; and the memory board reads and writes the PMEM storage module of the memory board of other nodes.

Priority arbiter: determining a priority through a memory access address and read and write commands, and storing concurrent memory access requests into the memory access queue. Since forward and reverse computations take the longest time in training, in order to ensure the training delay, the priority of a memory access operation of the acceleration device to access the memory board is set to the highest, while other memory access operations will be hidden in processes of the forward and reverse computations.

Computing unit: mainly completing weight collection and computation of each GPU during training.

Engine dcoh: Consistency tracking logic for device memory and host memory. In the CXL standard, the consistency of memory access may be guaranteed, and the memory accessed by the host and the acceleration device is the latest and consistent.

The network module is configured to support remote access between the memory boards in different hosts. Network protocols such as RDMA/TCP may be adopted. In this example, the RDMA is used as the communication method for description.

Main functions of the controller in the PEME storage module include memory allocation/release, data placement, address mapping, memory request scheduling, etc. PMEM is configured to store model weights and train data. Since the PMEM has the characteristics of no loss during power failure, and unit storage costs are lower than a double data rate (DDR), the PMEM is more suitable for large model training scenarios. The PMEM supports extended memory access in remote memory boards and uniformly addresses memory boards in network nodes. The boards use a CXL.IO protocol, and the address of network connection memory board may be mapped to the host memory space through IO (memory management unit (MMU). Users may use the virtual address space after address conversion to connect to the memory boards.

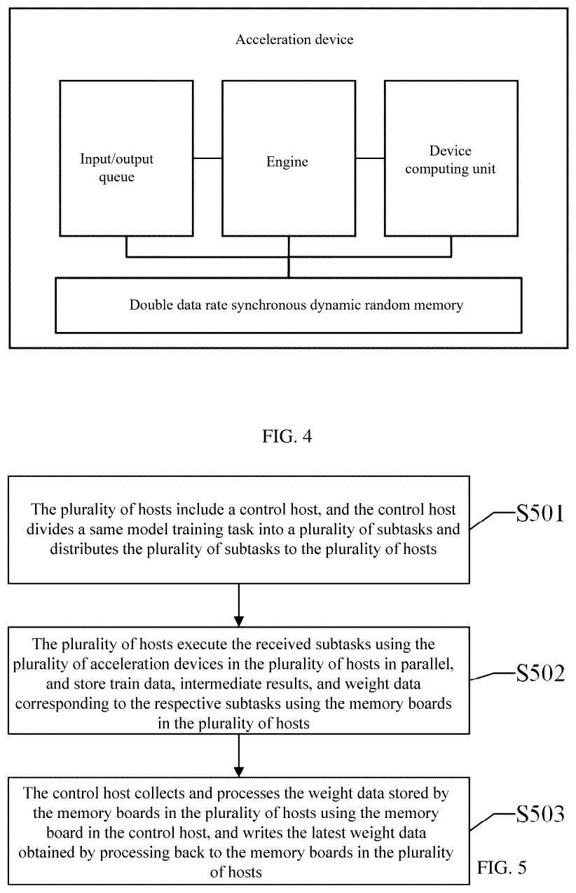

Referring to FIG. 4, the acceleration device is a GPU computing unit supporting the CXL protocol, including following modules: device consistency engine (DCOH), input output first input first output (I/O FIFO), a general purpose computing on GPU (GPGPU) computing module (device computing unit), and a double data rate (DDR) synchronous dynamic random memory. Among them, the GPGPU computing unit mainly completes the forward and reverse computation tasks in training; the I/O FIFO is responsible for pre-fetching train data/model weights and writing the model weights in training to the memory board; the DCOH is configured to implement the consistency tracking logic between device memory and host memory; and the DDR (i.e. subtask weight data area) stores the intermediate weights in the caching computing process.

In some examples, a model training process includes: first initializing extended memory of a host node in a cluster before training, and writing the extended memory of the node into a memory configuration file of each node. The configuration file includes an interaction mode, a size, and a start offset address of each memory board of the current host.

With three host nodes, and the expanded memory size of each node being 0x10000000 as an example, see Table 1 for memory information.

TABLE 1

| | Node 1 | Node 2 | Node 3 |
|---|---|---|---|
| | memory board | memory board | memory board |
| Node 1 expanded | PCIE: | RDMA: | RDMA: |
| memory addressing | 0x10000000 | 0x10000000 | 0x10000000 |
| | 0x00000000 | 0x10000000 | 0x20000000 |
| Node 2 expanded | RDMA: | PCIE: | RDMA: |
| memory addressing | 0x10000000 | 0x10000000 | 0x10000000 |
| | 0x00000000 | 0x10000000 | 0x20000000 |
| Node 3 expanded | RDMA: | RDMA: | PCIE: |
| memory addressing | 0x10000000 | 0x10000000 | 0x10000000 |
| | 0x00000000 | 0x10000000 | 0x20000000 |

Through the above unified addressing, each node has the access right to the extended memory of other nodes. It is ensured that the base address+offset memory address in the memory board in each node points to the unique physical memory. According to Table 1, a memory board supports both PCIE communication and RDMA communication.

Start training: Since the model is so large that a single GPU memory may not be put down, the training adopts a node-based model parallelism strategy of splitting the model into the GPU of each node for running. In some embodiments, the GPU in each node runs to co-split one model. The model consists of multiple layers, and each layer is split into N GPUs for computation. As distributed training, one of the nodes is selected as the control host (master host) which is responsible for starting the training task and sending training parameters to other nodes. Each node is responsible for burning and starting the acceleration device and a memory board kernel program, and passing the training parameters received from the control host to the acceleration device and memory board program.

The initialization training parameter configuration includes: allocating memory on the memory board according to the size of the model, which is divided into 4 parts: a train data area, a model weight area, a layer weight area of a certain layer in the model, other memory areas. Because a data set of model training is extremely large, the data set needs to be stored in the memory board of each node in batches. Since the read delay of PCIE is less than that of RDMA, the train data is stored in the non-volatile storage area of the local memory board.

A local weight block of each node is initialized. This memory is configured to store a local weight currently being computed, exists in the local memory board memory of each node, reduces communication delay, and is allocated to local DDR storage. Compared with the PMEM, read and write performance may be improved. This part of the memory will be accessed by the master node for average value computation. The data will be updated and then written back. The update data is the average value of the data of the node. In order to prevent read-write conflicts, this area is designed as a pingpong cache, and at the same time, flag bits are designed. When the acceleration device updates the local weight, position 1 is flagged. When the computing unit in the memory board finds that the flag is 1, the average value is computed and written to the model weight area. Then the flag is set to 0. Because the update weight of the acceleration device is the data of a certain layer of the model, and the average value computation time of the memory board is much less than the update time of the acceleration device (the computation/training time of this layer of the model), access conflicts are avoided.

The train data is read to the GPU memory: This operation is completed by the I/O FIFO module of the acceleration device. The module is responsible for pre-fetching the train data from the train data area of the memory board, and storing the train data in the data FIFO. The data is then read by the GPGPU computing module of the acceleration device.

Segmented reading of model weights: Since the model is large, model segmentation is configured to divide the weight of each layer into each acceleration device according to the number of GPUs in a single node, which may be divided according to the amount of computation. Assuming that each node has two GPUs, the layer is split into two GPUs according to the amount of computation, which may ensure that the two GPUs may complete computations at the same time and reduce waiting time required for synchronization. This operation is also completed by the I/O FIFO module of the acceleration device. The module is responsible for pre-fetching the train data from the model weight area of the memory board, which stores the average weight value of the last trained model, and storing the train data in the weight FIFO. The data is then read by the GPGPU computation module of the acceleration device. By reading the model weights in layers/blocks, a local GPU memory footprint may be reduced, and a small amount of model weights and intermediate data need to be cached locally.

Forward computation: Each node performs forward computation according to the read data and weight, and the model loss of each node is computed.

Partial reverse computation: The reverse computation is also performed in blocks and is completed by the GPGPU module of the acceleration device.

GPU updating of local weights: After computation of the weight of each node, the weight is stored in video memory of the acceleration device.

The model weight is stored to the node memory board DDR: This operation is completed by the I/O FIFO module of the acceleration device. This module will record the last pingpong address sent and written to the memory board, read the local video memory weight of the acceleration device and store the weight to the corresponding weight area of the PMEM. When the cache area is full, the flag is set to 1.

Updating of PMEM model weight: The computation module of the memory board reads the pingpong cache of the weight of each node, computes the average value, stores the value in the model weight memory in the pmem memory, and sets the flag to 0. Because the average value computation time of the memory board is much less than the update time of the acceleration device, a timer mode is adopted to read the flag bits.

The aforementioned process is repeated until back propagation of all model blocks is completed.

It may be seen that in these embodiments, the train data, the training intermediate results, and the training weights are stored to the memory board device through the CXL bus PMEM memory expansion device, and the distributed training device only needs to save one model weight by using the unified addressing of the cxl mem across nodes, which greatly saves model cache space, thereby implementing distributed large model training in a small-scale cluster; The entire training process only requires a small amount of CPU to participate, and a large amount of computing and memory access work is offloaded to the cxl device, thus greatly saving GPU memory, computing power and bandwidth. A power-down no-loss feature of the PMEM may greatly reduce the risk of downtime during training and the difficulty to restore the model weight data, thereby achieving the effect of expanding GPU memory and CPU memory, and thus supporting training of large models in small-scale clusters.

Hereinafter, a data processing method provided by some embodiments of the present application will be described, and a data processing method described below and other embodiments described herein may be cross-referenced.

Referring to FIG. 5, some embodiments of the present application discloses a data processing method, which is applied to a distributed system, where the distributed system includes a plurality of hosts, and any host includes: a plurality of acceleration devices and at least one memory board.

S501: The plurality of hosts include a control host, and the control host divides a same model training task into a plurality of subtasks and distributes the plurality of subtasks to the plurality of hosts.

S502: The plurality of hosts execute the received subtasks using the plurality of acceleration devices in the plurality of hosts in parallel, and store train data, intermediate results, and weight data corresponding to the respective subtasks using the memory boards in the plurality of hosts.

S503: The control host collects and processes the weight data stored by the memory boards in the plurality of hosts using the memory board in the control host, and writes the latest weight data obtained by processing back to the memory boards in the plurality of hosts.

In some implementations, a network module in any memory board synchronizes the weight data stored by the current memory board to the memory boards in the other hosts through a remote direct memory access (RDMA) protocol; and receives the weight data sent by the memory boards in the other hosts through the RDMA protocol.

In some implementations, the control host initializes the memory boards in the plurality of hosts, configures an interaction mode, a memory size and a start offset address of each memory board, uniformly addresses each memory board to obtain an addressing table, and enables access rights between the memory boards.

In some implementations, any memory board includes: a non-volatile storage module, where the non-volatile storage module includes a storage controller and a non-volatile storage area.

The storage controller is configured to perform a memory allocation operation, a memory release operation, a data storage operation, an address mapping operation and/or memory request scheduling on the non-volatile storage area.

The non-volatile storage area is configured to respond to the memory allocation operation, the memory release operation, the data storage operation, the address mapping operation, and/or the memory request scheduling performed by the storage controller.

In some implementations, the non-volatile storage area is divided into a train data area, a full model weight data area, a subtask weight data area, and other areas.

In some implementations, any memory board further includes: a board scheduler, where the board scheduler is configured to implement data consistency between memory of the host to which the current memory board belongs and the non-volatile storage area in the current memory board by a compute express link (CXL) protocol.

In some implementations, any memory board further includes: a priority arbiter.

The priority arbiter determines a priority according to a memory access address in a received memory access request, and processes the memory access request according to the determined priority. In some embodiments, the memory access request is a request for a host to which a current memory board belongs to access the non-volatile storage area in the current memory board, a request for the acceleration devices in a host to which a current memory board belongs to access the non-volatile storage area in the current memory board, a request for a current memory board to access the non-volatile storage area in the current memory board, and/or a request for a current memory board to access a memory board in another host. It is thus clear that the system supports the host to which the current memory board belongs to access the non-volatile storage area in the current memory board, the acceleration devices in the host to which the current memory board belongs to access the non-volatile storage area in the current memory board, the current memory board to access the non-volatile storage area in the current memory board and/or mutual access of the memory boards of different hosts. In some embodiments, the priority arbiter determines that the memory access request is a request for the acceleration devices in the host to which the current memory board belongs to access the non-volatile storage area in the current memory board, and thus determines that the priority is the highest. In some embodiments, the priority arbiter determines the priority according to a preset strategy in response to determining that the memory access request is not a request for the acceleration devices in the host to which the current memory board belongs to access the non-volatile storage area in the current memory board. In some embodiments, in the preset strategy, the priorities of the different requests may be set, for example: the priority of the request for the acceleration devices in the host to which the current memory board belongs to access the non-volatile storage area in the current memory board is the highest, the priority of the request for the current memory board to access the non-volatile storage area in the current memory board is the second, the priority of the mutual access of the memory boards of different hosts is the third, and the priority of the request for the host to which the current memory board belongs to access the non-volatile storage area in the current memory board is the lowest.

In some implementations, any memory board further includes: a board computing unit, where the board computing unit is configured to collect and compute the weight data.

In some implementations, any memory board further includes: a network module, where the network module is configured to communicate with a memory board in another host through a target protocol.

In some implementations, the network module synchronizes the weight data stored by the memory board to which the network module belongs to the memory boards in the other hosts through an RDMA protocol; and receives the weight data sent by the memory boards in the other hosts through the RDMA protocol.

In some implementations, the control host initializes the memory boards in the plurality of hosts, configures an interaction mode, a memory size and a start offset address of each memory board, uniformly addresses each memory board to obtain an addressing table, and enables access rights between the memory boards.

In some implementations, any host or any memory board or any acceleration device accesses a target memory address through a base address and an offset address corresponding to the target memory address, where the target memory address is an address of a non-volatile storage area in a non-current memory board.

In some implementations, any host maps an address of the non-volatile storage area in the memory board of the host to host memory space through a CXL protocol, and implements conversion between a host memory address and a board memory address according to an address mapping relationship obtained by mapping.

In some implementations, any host divides the received subtask into a plurality of task blocks according to the number of the acceleration devices in the host, distributes the plurality of task blocks to the acceleration devices in the host, and controls the acceleration devices in the host to run the plurality of task blocks in parallel. It is thus clear that the different acceleration devices in the same host run the subtask received by the host in parallel, thereby accelerating a task processing rate.

In some implementations, the control host computes an average value of the weight data stored by the memory boards in the plurality of hosts, and takes the average value as the latest weight data.

In some implementations, any acceleration device includes a device scheduler, where the device scheduler is configured to implement data consistency between memory of a current acceleration device and memory of a host to which the current acceleration device belongs through the CXL protocol.

In some implementations, any acceleration device includes a plurality of device computing units, where the plurality of device computing units are configured to execute the received task block; and the task block is obtained by dividing the subtask received by the current acceleration device according to the number of the acceleration devices in the host to which the current acceleration device belongs.

In another aspect, any host or any memory board or any acceleration device determines that the target memory address is local according to the addressing table, and accesses the target memory address through a peripheral component interconnect express (PCIE) protocol; and/or any host or any memory board or any acceleration device determines that the target memory address is not local according to the addressing table, and accesses the target memory address through the RDMA protocol. Any acceleration device stores intermediate weights in a training process obtained by executing the subtask into the subtask weight data area of the memory board of a same host; and sets a flag corresponding to the subtask weight data area from 0 to 1 in response to determining that the subtask weight data area is full. Accordingly, the board computing unit in any memory board reads the intermediate weights in a local or remote subtask weight data area according to the addressing table, and sets a flag corresponding to the respective subtask weight data area from 1 to 0; and computes an average value of the read data, and writes the average value to a local or remote full model weight data area according to the addressing table.

Here, the corresponding contents disclosed in the foregoing embodiments may be referred to for a working process of each module and unit in these embodiments. This will not be repeatedly described herein.

It is thus clear, according to these embodiments, a model training task is executed using acceleration devices in a host; and train data, intermediate results and weight data are stored using a memory board in the host, whereby the host does not need to execute the task or store the data. In this way, a load of the host is reduced. The acceleration devices execute the model training task, whereby the model training efficiency may be improved. In a hole training process, the host is needed for task distribution. A lot of computing and memory access work is offloaded to the acceleration devices and the memory board, whereby down risks in the training process and the difficulty to restore the model weight data may be reduced.

Hereinafter, an electronic device provided by some embodiments of the present application will be described. The electronic device described below and other embodiments described herein may be cross-referenced. The electronic device in these embodiments may be a host, a memory board, or an acceleration device in the above embodiments.

Some embodiments of the present application disclose an electronic device, including:
one or more processors; and
a memory associated with the one or more processors, where the memory is configured to store computer-readable instructions that, when read and executed by the one or more processors, implement the methods disclosed in any of the embodiments described above.

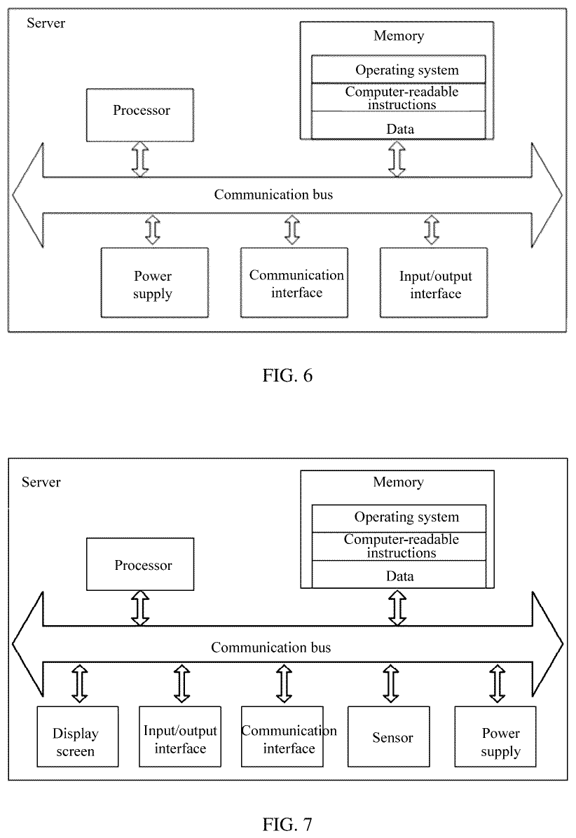

Further, some embodiments of the present application further provide an electronic device. Here, the electronic device may be a server as shown in FIG. 6 or a terminal as shown in FIG. 7. FIG. 6 and FIG. 7 are both structural diagrams of the electronic device shown according to some exemplary embodiments, and the contents in the drawings may not be regarded as any limitation on the scope of use of the present application.

FIG. 6 is a schematic structural diagram of a server provided by some embodiments of the present application. The server may include: at least one processor, at least one memory, a power supply, a communication interface, an input/output interface, and a communication bus. In some embodiments, the memory is configured to store computer-readable instructions, the computer-readable instructions being loaded and executed by the processor to implement relevant steps in the data processing disclosed in any of the foregoing embodiments.

In these embodiments, the power supply is configured to provide an operating voltage for each hardware device on the server; the communication interface may create a data transmission channel between the server and an external device, and a communication protocol followed by the communication interface is any communication protocol applicable to the technical solution of the present application, and is not limited herein; the input/output interface is configured to acquire external input data or output data to outside, where an interface type thereof may selected according to application needs, and is not limited here.

In addition, as a carrier for resource storage, the memory may be a read-only memory, a random access memory, a magnetic disk, an optical disk, or the like. The resources stored therein include an operating system, computer-readable instructions, data, and the like. A storage means may be temporary storage or permanent storage.

In some embodiments, the operating system is configured to manage and control various hardware devices on the server and computer-readable instructions to implement operation and processing of data in the memory by the processor. The system may be Windows Server, Netware, Unix, Linux, etc. The computer-readable instructions may further include computer-readable instructions configured to perform other tasks in addition to computer-readable instructions configured to perform the data processing method disclosed in any of the foregoing embodiments. The data may include, in addition to data such as update information of an application, data such as developer information of the application.

FIG. 7 is a schematic structural diagram of a terminal provided by some embodiments of the present application. The terminal may include but is not limited to a smartphone, a tablet computer, a notebook computer, a desktop computer, or the like. Generally, the terminal in these embodiments includes: one or more processors and a memory associated with the one or more processors.

The processor may include one or more processing cores, such as a 4-core processor, an 8-core processor, or the like. The processor may be implemented in at least one hardware form of digital signal processing (DSP), a field-programmable gate array (FPGA), and a programmable logic array (PLA). The processor may also include a main processor and a coprocessor. The main processor is a processor for processing data in a wake-up state, also called a central processing unit (CPU). The coprocessor is a low-power processor for processing data in a standby state. In some embodiments, the processor may be integrated with a graphics processing unit (GPU) that is responsible for rendering and rendering content that a display screen needs to display. In some embodiments, the processor may further include an artificial intelligence (AI) processor for processing computation operations related to machine learning.

The memory may include one or more computer-readable storage media which may be non-transitory. The memory may further include a high-speed random access memory, as well as a non-volatile memory, such as one or more magnetic disk storage devices, and flash storage devices. In these embodiments, the memory is at least configured to store the following computer-readable instructions, where, after the computer-readable instructions are loaded and executed by the processor, related steps in the data processing method executed by a terminal side disclosed in any of the foregoing embodiments may be implemented. In addition, resources stored in the memory may also include an operating system, data, and the like. A storage means may be temporary storage or permanent storage. In some embodiments, the operating system may include Windows, Unix, Linux, and the like. The data may include, but is not limited to, update information for an application.

In some embodiments, the terminal may further include a display screen, an input/output interface, a communication interface, a sensor, a power supply, and a communication bus.

It will be understood by those skilled in the art that the structure shown in FIG. 7 does not constitute a limitation of the terminal and may include more or fewer components than shown.

Hereinafter, a readable storage medium provided by some embodiments of the present application will be described. The readable storage medium described below and other embodiments described herein may be cross-referenced. In some embodiments, the readable storage medium is a computer-readable storage medium. As a carrier for resource storage, the medium may be a read-only memory, a random access memory, a magnetic disk, an optical disk, or the like. The resources stored therein include an operating system, computer-readable instructions, data, and the like. A storage means may be temporary storage or permanent storage.

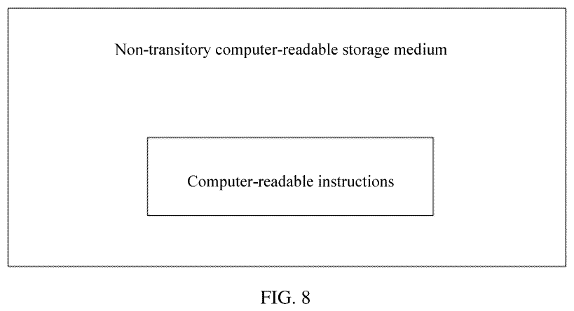

As shown in FIG. 8, a structural diagram of a non-transitory computer-readable storage medium is provided. The non-transitory computer-readable storage medium stores computer-readable instructions that, when executed by one or more processors, implement the data processing method disclosed in the foregoing embodiments.

In these embodiments, the computer-readable instructions executed by the processor may implement the following steps: performing a memory allocation operation, a memory release operation, a data storage operation, an address mapping operation and/or memory request scheduling on the non-volatile storage area; and responding to the memory allocation operation, the memory release operation, the data storage operation, the address mapping operation, and/or the memory request scheduling performed by the storage controller. In some embodiments, the non-volatile storage area is divided into a train data area, a full model weight data area, a subtask weight data area, and other areas.

In this specification, each embodiment is described in a stepwise manner, and the differences between each embodiment and other embodiments are emphasized, and the same or similar parts between each embodiment may be referred to each other.

The steps of the methods or algorithms described in connection with the embodiments disclosed herein may be implemented directly in hardware, a processor-executed software module, or a combination of both. The software module may be placed in a random access memory (RAM), memory, a read-only memory (ROM), an electrically programmable ROM, an electrically erasable programmable ROM, a register, a hard disk, a removable magnetic disk, a compact disc read-only memory (CD-ROM), or any other form of readable storage medium known in the art.

Herein, examples are configured to explain the principles and implementations of the present application, and the description of the above embodiments is only for helping to understand the methods and core ideas of the present application. Meanwhile, those of ordinary skill in the art may change the implementations and the scope of application according to the ideas of the present application, and in summary, the contents of the present specification should not be construed as limiting the present application.

1. A data processing system, comprising a plurality of hosts, any host comprising: a plurality of acceleration devices and at least one memory board; the plurality of hosts comprising a control host;
the control host dividing a same model training task into a plurality of subtasks and distributing the plurality of subtasks to the plurality of hosts;
the plurality of hosts executing received subtasks using the plurality of acceleration devices in the plurality of hosts in parallel, and storing train data, intermediate results, and weight data corresponding to the respective subtasks using memory boards in the plurality of hosts; and
the control host collecting and processing the weight data stored by the memory boards in the plurality of hosts using a memory board in the control host, and writing latest weight data obtained by processing back to the memory boards in the plurality of hosts.

2. The system according to claim 1, wherein any of the memory boards comprises: a non-volatile storage module, the non-volatile storage module comprising a storage controller and a non-volatile storage area;
the storage controller configured to perform at least one of a memory allocation operation, a memory release operation, a data storage operation, an address mapping operation or memory request scheduling on the non-volatile storage area; and
the non-volatile storage area configured to respond to at least one of the memory allocation operation, the memory release operation, the data storage operation, the address mapping operation, or the memory request scheduling performed by the storage controller.

3. The system according to claim 2, wherein the non-volatile storage area is divided into a train data area, a full model weight data area, a subtask weight data area, and other areas.

4. The system according to claim 2, wherein any of the memory boards further comprises: a board scheduler,
the board scheduler being configured to implement data consistency between memory of a host to which a current memory board belongs and the non-volatile storage area in the current memory board by a compute express link (CXL) protocol.

5. The system according to claim 2, wherein any of the memory boards further comprises: a priority arbiter,
the priority arbiter determining a priority according to a memory access address in a received memory access request, and processing the received memory access request according to a determined priority.

6. The system according to claim 5, wherein the received memory access request is at least one of a request for a host to which a current memory board belongs to access the non-volatile storage area in the current memory board, a request for an acceleration device in the host to which the current memory board belongs to access the non-volatile storage area in the current memory board, a request for the current memory board to access the non-volatile storage area in the current memory board, or a request for the current memory board to access a memory board in another host.

7. The system according to claim 5, wherein the priority arbiter determines that the priority is highest by determining that the received memory access request is a request for an acceleration device in a host to which a current memory board belongs to access the non-volatile storage area in the current memory board.

8. The system according to claim 5, wherein the priority arbiter determines the priority according to a preset strategy in response to determining that the received memory access request is not a request for an acceleration device in a host to which a current memory board belongs to access the non-volatile storage area in the current memory board.

9. The system according to claim 2, wherein any of the memory boards further comprises: a board computing unit, the board computing unit being configured to collect and compute the weight data.

10. The system according to claim 2, wherein any of the memory boards further comprises: a network module, the network module being configured to communicate with a memory board in another host through a target protocol.

11. The system according to claim 10, wherein the network module is configured to:
synchronize the weight data stored by a first memory board to which the network module belongs to a second memory board in the another host through a remote direct memory access (RDMA) protocol; and
receive the weight data sent by the second memory board in the another host through the RDMA protocol.

12. The system according to claim 1, wherein the control host initializes the memory boards in the plurality of hosts, configures an interaction mode, a memory size and a start offset address of each of the memory boards, uniformly addresses each of the memory boards to obtain an addressing table, and enables access rights between the memory boards.

13. The system according to claim 12, wherein any of the plurality of hosts or any of the memory boards or any of the plurality of acceleration devices accesses a target memory address through a base address and an offset address corresponding to the target memory address, the target memory address being an address of a non-volatile storage area in a non-current memory board.

14. The system according to claim 13, wherein at least one of:
any host of the plurality of hosts or any of the memory boards or any of the plurality of acceleration devices determines that the target memory address is local according to the addressing table, and accesses the target memory address through a peripheral component interconnect express (PCIE) protocol; or
any of the plurality of hosts or any of the memory boards or any of the plurality of acceleration devices determines that the target memory address is not local according to the addressing table, and accesses the target memory address through a remote direct memory access (RDMA) protocol.

15.-17. (canceled)

18. The system according to claim 1, wherein any of the plurality of acceleration devices comprises a device scheduler, the device scheduler being configured to implement data consistency between memory of a current acceleration device and memory of a host to which the current acceleration device belongs through a compute express link (CXL) protocol.

19. The system according to claim 18, wherein any of the plurality of acceleration devices comprises a plurality of device computing units, the plurality of device computing units being configured to execute a received task block; and the received task block is obtained by dividing a subtask received by the current acceleration device according to a number of the plurality of acceleration devices in the host to which the current acceleration device belongs.

20. The system according to claim 19, wherein any of the plurality of acceleration devices stores intermediate weights in a training process obtained by executing the subtask into a subtask weight data area of the memory boards of a same host; and sets a flag corresponding to the subtask weight data area from 0 to 1 in response to determining that the subtask weight data area is full.

21. The system according to claim 20, wherein a board computing unit in any of the memory boards is configured to:
read the intermediate weights in a local or remote subtask weight data area according to an addressing table, and set a flag corresponding to a respective subtask weight data area from 1 to 0; and
compute an average value of read data, and write the average value to a local or remote full model weight data area according to the addressing table.

22. A data processing method, wherein the data processing method is applied to a distributed system, the distributed system comprising a plurality of hosts, and any host comprises: a plurality of acceleration devices and at least one memory board; the plurality of hosts comprising a control host; the method comprising:
the control host dividing a same model training task into a plurality of subtasks and distributing the plurality of subtasks to the plurality of hosts;
the plurality of hosts executing received subtasks using the plurality of acceleration devices in the plurality of hosts in parallel, and storing train data, intermediate results, and weight data corresponding to the respective subtasks using memory boards in the plurality of hosts; and
the control host collecting and processing the weight data stored by the memory boards in the plurality of hosts using a memory board in the control host, and writing latest weight data obtained by processing back to the memory boards in the plurality of hosts.

23. A readable storage medium, storing computer programs, wherein the computer programs, when executed by a processor, implement a data processing method, wherein the data processing method is applied to a distributed system, the distributed system comprising a plurality of hosts, and any host comprises: a plurality of acceleration devices and at least one memory board; the plurality of hosts comprising a control host; the method comprising:
the control host dividing a same model training task into a plurality of subtasks and distributing the plurality of subtasks to the plurality of hosts;
the plurality of hosts executing received subtasks using the plurality of acceleration devices in the plurality of hosts in parallel, and storing train data, intermediate results, and weight data corresponding to the respective subtasks using memory boards in the plurality of hosts; and
the control host collecting and processing the weight data stored by the memory boards in the plurality of hosts using a memory board in the control host, and writing latest weight data obtained by processing back to the memory boards in the plurality of hosts.
